(19) United States
(12) Patent Application Publication
(10) Pub. No.: US 2010/0057615 A1
(43) Pub. Date: Mar. 4, 2010

(54) Method of transferring money

(76) Inventor: John Klett, Santa Barbara, CA (US)

Correspondence Address: SANDRA LEE LIPKIN A LAW CORPORATION, P.O.Box 3518, VENTURA, CA, 93006, US

(21) Appl. No.: 12/231,016

(22) Filed: Aug. 27, 2008

(51) Int. Cl. G06Q 40/00

(52) U.S. Cl. 705/43; 705/44

(57) ABSTRACT

A Method of Transferring Money includes the steps of: Accepting Information from a Sender, Creating a PIN (Personal Identification Number) for Sender, Accepting funds from Sender, Wiring Funds to a Central Bank Account, Accepting a PIN Number from a Recipient, Comparing PIN Number provided by Recipient with PIN Number created for Sender, Disbursing Funds to Recipient.

### FIELD OF THE INVENTION

The present invention relates with a system for transferring money from a sender to a recipient through a unique method.

### BACKGROUND OF THE INVENTION

One of the largest conduits of revenue transfers are through wiring services. Mexico, in particular, receives as its second largest revenue streams, wired money transfers from families who work in the United States to families who live in Mexico. Oftentimes, the people who wire the money to their families are “unbanked”. In other words, they cannot avail themselves of traditional banking services. This inability is often attributed to various restrictions concerning citizenship, taxes, and fear of various unknown laws. In addition, the unbanked are often deprived of various web-enabled wire transfer companies. Also, due to their particular situation, many of the unbanked do not have quick and convenient access to a retail access point to wire their funds back to their native country.

One of the reasons that banks and related financial institutions are hampered from providing services to the unbanked is the affirmative requirement that those institutions comply with the “know thy customer” provisions set forth in many anti-money laundering laws. This requirement makes their services logistically prohibitive from their side, and unrealistic from the perspective of the unbanked due to various fears related with citizenship, immigration status, etc.

Another logistical hurdle precluding the unbanked from traditional wire services is that most web-enabled payment providers cannot offer their services to the unbanked due to their lack of “brick and mortar” retail access points.

Therefore, what is clearly needed is a method which provides for a system which can enable more people to gain access to reasonably priced wire transfer services. The method should enable the unbanked to avail themselves of various web-enabled wire transfer companies through “brick and mortar” retail access points. Through this method, the web-enabled wire transfer companies may compete directly with existing wire transfer companies such as Western Union.

### SUMMARY OF THE INVENTION

It is an object of the present invention to bring together: users who desire to wire money to another person or entity, the web-enabled wire transfer companies, and banks for the collective endeavor of providing wire transfer services with less fees, more access, and convenience hitherto unavailable.

It is an object of the present invention to provide web-enabled wire transfer companies a “brick and mortar” retail access point. The present invention can also enable banks to furnish their services to the same. These services are made possible by outsourcing various compliance duties to the web-enabled wire transfer companies such as the “know thy customer” provisions of various anti-money laundering statutes.

It is an object of the present invention to provide wire transfer services to the unbanked with reduced transactional fees. This is made possible by utilizing the latest in electronic financial services platforms and Internet web-enabled payment solutions methodologies. By using this unique method, various fixed costs will be either reduced or eliminated redounding to the benefit of those who cannot avail themselves of traditional banking institutions and their attendant services.

It is an object of the present invention to enable Internet-based wire transfer companies without “brick and mortar” retail access points use of traditional, close, and convenient “brick and mortar” retail access points. In many instances these “brick and mortar” retail access points will not incur large expenditures of capital because they may be vertically-integrated with various retail stores which can likewise benefit from the wire transfer services. These “brick and mortar” retail access points may serve as a conduit between the Internet-based wire transfer companies and the unbanked, or the end users.

It is an object of the present invention to provide services in compliance with relevant statutes. By requesting various information, the unbanked may transmit funds while complying with various anti-laundering statutes, “know your customer” statutes, etc. by providing various identifying information about the sender and the recipient. The capture of various identifying information about the sender and the recipient by the wire transfer company is consistent with guidelines adopted and adhered to by Western Union and other retail wire transfer companies whereby limits of under $3,000 and lower and frequencies of wire transfers allowed by law require no physical identification to be furnished.

It is an object of the present invention to provide more convenient locations as to where the sender and the recipient may send and receive the funds. By utilizing heavily frequented stores such as mini-marts, grocery stores, coffee shops, fast food restaurants, etc., both the sender and the recipient will have greater access to funds even if they may live in relatively rural areas.

It is an object of the present invention to enable a sender to specifically specify how funds are to be spent for various goods or services when the funds are wired to a specific store, or similar location for the benefit of the recipient. As the funds are wired to the store, the recipient may be restricted to the particular goods, services, or cash as per specific instructions provided by the sender.

It is also an object of the present invention to provide a method for utilizing ATM's as a retail remittance point where the receiver may receive the wire transfer. This is made possible through a system whereby a single ATM Card is used to dispense the funds. This store-issued ATM card is maintained by the retail store proprietor. This store-issued ATM card is also part of the system so that the recipient does not need an ATM card to receive funds via an ATM machine. The use of a store-issued ATM Card allows for a broader network of remittance access points for the receiver because the retail store operator does not require cash on hand to dispense funds. Moreover, the store will not require additional security to protect those funds. This unique method enables for compliance with various laws to deter money laundering by requiring the recipient to show identification and fill out a form to receive the wire transferred funds.

### BRIEF DESCRIPTION OF THE DRAWING FIGURES

FIG. 1 is a schematic diagram of a preferred embodiment of the present invention.

FIG. 2 is a schematic diagram of a preferred embodiment of the present invention.

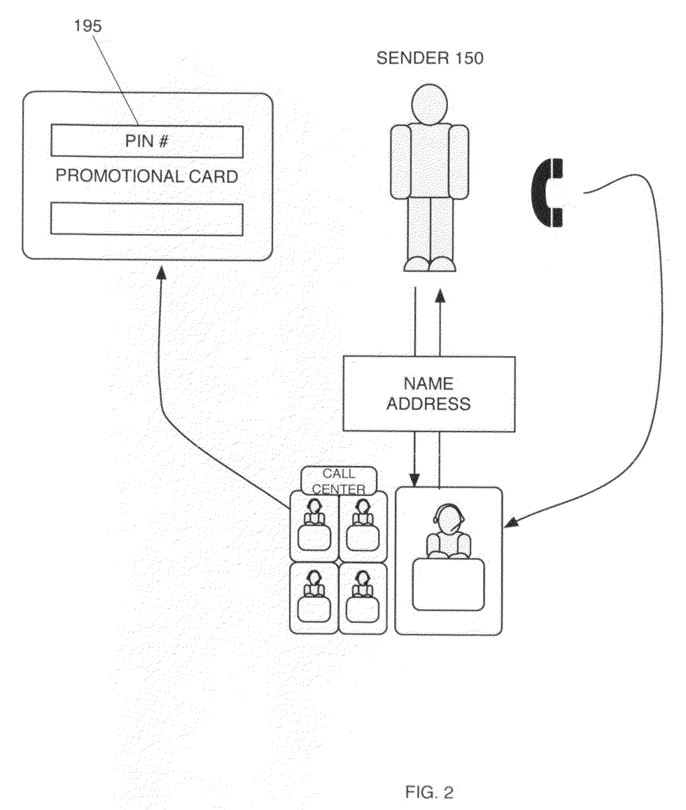

FIG. 3 is a schematic diagram of a preferred embodiment of the present invention.

FIG. 4 is a schematic diagram of a preferred embodiment of the present invention.

FIG. 5 is a schematic diagram of a preferred embodiment of the present invention.

### DESCRIPTION OF PREFERRED EMBODIMENTS

According to a preferred embodiment of the present invention, a unique method is used to enable a sender to transfer money to a recipient through various institutions without traditionally requested information and attendant protocols and modalities. The unique method is described in enabling detail below.

For the purposes of the present invention the term “Sender” shall hereafter refer to a person or entity who intends to send money to another person or entity. For the purposes of the present invention the term “Recipient” shall hereafter refer to a person or entity to whom the Sender intends to send money.

For the purposes of the present invention the term “Convenience Fees” shall refer to those fees charged by the WTC or other entity to fund the system for enabling the transaction between the Sender and the Recipient.

For the purposes of the present invention the term “Fund” or “Funds” shall refer to money, cash, or various cash equivalents. It should also be noted here that the term “Fund” or “Funds” shall further include both the principal to be furnished by a sender and attendant “convenience fees” or related transaction fees. Furthermore, in some cases, the term “Fund” or “Funds” shall further include various taxes or other monies required to consummate the money transaction. In some preferred embodiments, various “convenience fees” may be required by either the Sender or the Recipient by the WTC”. In other preferred embodiments a “convenience fee” or related transaction fees might not be required.

For the purposes of the present invention the term “ATM” (Automated Teller Machine) shall hereafter refer to any machine or device to which a Sender or User interfaces to execute various steps performed in the present invention. In some preferred embodiments, an ATM Machine may be equipped with cash-scanning technology to accept cash from a Sender to be transferred to a Recipient.

For the purposes of the present invention the term “Store” or “Retail Outlet” shall hereafter refer to those stores wherein a Sender or Recipient may initiate, consummate, or otherwise interface with an ATM.

For the purposes of the present invention the term “WTC” (Wire Transfer Company” shall hereafter refer to the entity ultimately responsible for actuating the transaction from start to finish. It should be noted that the WTC may actually use another wire transfer entity to operate various wire transfers. Also, the WTC may also enlist various institutions for various clearinghouse services as well. Therefore, the term “WTC” is not intended to imply that one particular entity operates all transactions mentioned in the present invention.

For the purposes of the present invention a VRU (Voice Response Unit) is a computer-operated system which provides pre-recorded voice messages to a caller and accepts voice inputs from a caller.

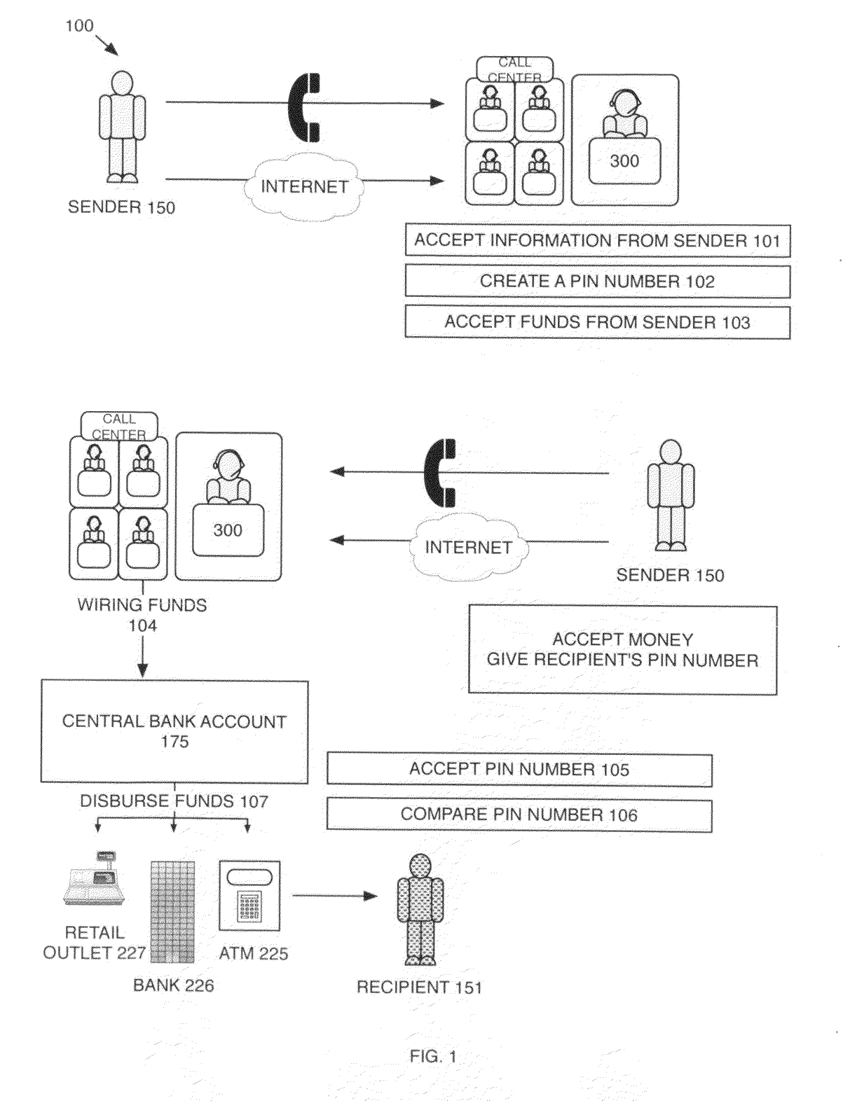

FIG. 1 illustrates a preferred embodiment of the present invention. A Method of Transferring Money 100 includes the steps of: Accepting Information 101 from a Sender 150, Creating a PIN (Personal Identification Number) 102 for Sender 150, Accepting funds 103 from Sender 150, Wiring Funds 104 to a Central Bank Account 175, Accepting a PIN Number 105 from a Recipient 151, Comparing PIN Number 106 provided by Recipient 151 with PIN Number 195 created for Sender 150, Disbursing 107 Funds to Recipient 151.

In some preferred embodiments of the present invention the Sender 150 initiates the process by contacting a Call Center 300. The Sender 150 may initiate contact either through phone or through an internet based website. In other preferred embodiments, the Call Center 300 may be substituted for an Agent or kiosk found in a place known to the Sender 150. It should be understood here that the Call Center 300 may be operated through either Agents (employees) or through a VRU.

The PIN Number 195 may be issued to the sender through a system-generating (by a computer) PIN program in some preferred embodiments. In other preferred embodiments, the PIN Number 195 may be chosen by the Sender 150 provided that the PIN Number 195 is adequately safe and logistically probable to issue. In some preferred embodiments, the PIN Number 195 may be furnished to the user on the back a user-issued card. This PIN Number 195 may be obscured by a film (commonly known as a “scratch-off”) to be removed by the user.

The Sender 150 may furnish funds to the WTC through a panoply of various means, methods and modalities. In some preferred embodiments, the Sender 150 may furnish funds to the WTC by simply using a credit card, debit card, value-added card, check, etc. In some preferred embodiments, the Sender 150 may simply establish a line of credit with the WTC whereby the Sender 150 will establish a creditor/debtor relationship. The means and modalities through which a Sender 150 may furnish funds to the WTC are immeasurable and are not to be construed to be limiting the scope of the present invention.

In order to comply with various regulatory laws such as money laundering statutes, and “Know Your Customer” requirements, the Call Center 300 asks Sender 150 for his or her name, address, and other information to come into compliance with relevant statutes. In addition, the Call Center 300 may request information about the name of the Recipient 151, the address of the Recipient 151, and the remittance point or destination. Other information required to comply with relevant statutes may also be requested from Sender 150 vis-à-vis the Recipient 151.

Upon accepting information regarding sender 150 and Recipient 151 as well as the funds and furnishing a PIN to Sender 150, the WTC may subsequently wire funds to a Central Bank Account 175. The Central Bank Account 175 is a centralized account wherein various monies and funds are commingled and await transfer to a Recipient 151. The funds are earmarked to each Sender 150 and Recipient 151 through the PIN Number 195 as well as other attendant information.

In order for the funds to be acquired by the Recipient 151, the Recipient 151 must interface with an ATM 225, Bank 226, or other Retail Outlet 227 in communication with the WTC and which can accept funds from the Central Bank Account 175. After providing the PIN Number 195 (furnished to Recipient 151 by Sender 150) as well as other confirming information, the funds are wired to the ATM 225, Bank 226, or other Retail Outlet 227, and therethrough furnished to Recipient 151.

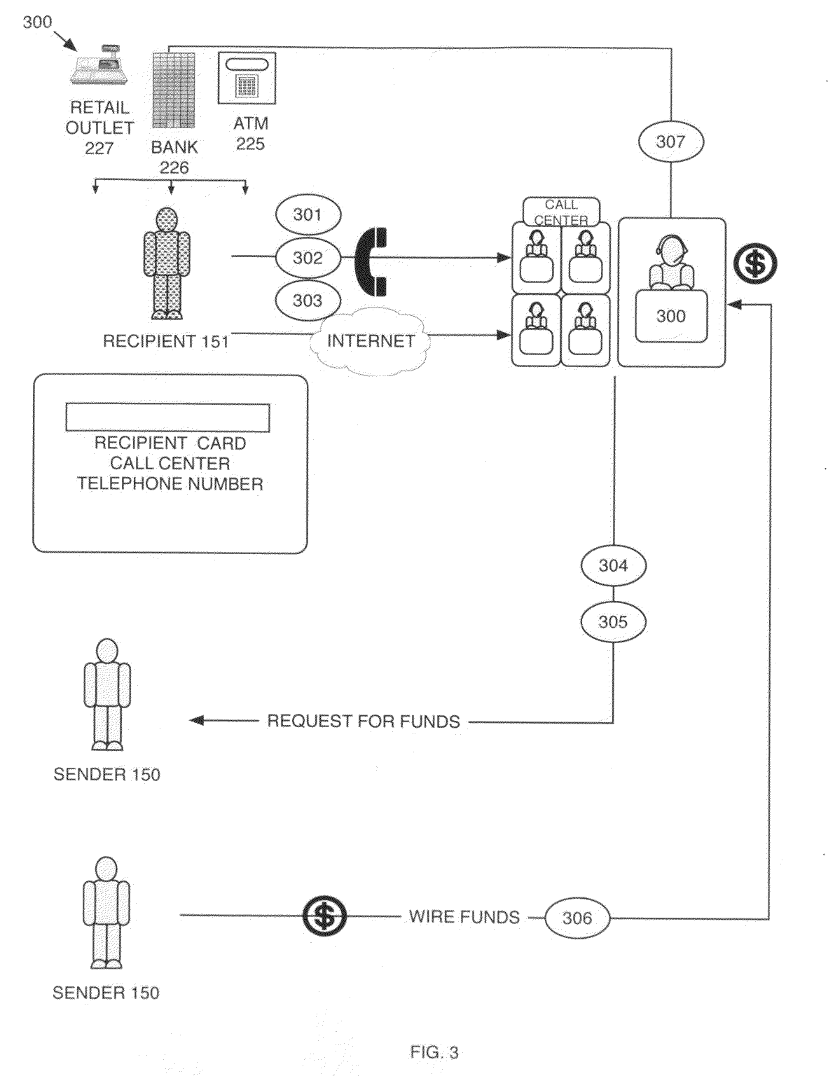

FIG. 3 illustrates another preferred embodiment of the present invention. A Recipient Initiated Transfer Method 300 includes the steps of: 1. Accepting 301 a request from a Recipient for funds from a Sender, 2. Accepting identifying information 302 from the Recipient about the Recipient and the sender, 3. Creating a PIN Number or Password 303 for the Recipient, 4. Contacting 304 the Sender, 5. Requesting funds 305 from Sender and providing a PIN number to Sender, 6. Receiving Funds 306 from the Sender, and 7. Wiring or Sending funds 307 to the Recipient.

It should be noted here that it may be preferable for the WTC to contact and interface with the Sender 150 through an email account previously established and operated by the Sender 150. The reason for this is that the communication can be instantaneous and may provide the PIN Number 195 and/or Password set up by Recipient 151. However, other modalities of communication and interactions previously mentioned can also be used as well.

It should be noted here that in this preferred embodiment, the WTC need not compare the PIN Number 195 for accuracy. The PIN Number 195 or other password will be compared by the Sender 150. As the Sender 150 receives the PIN Number 195 from the WTC, the Sender 150 will confirm the accuracy of the PIN Number 195 or password. It is to be assumed that the Recipient 151 will inform the Sender 150 the PIN Number 195 or Password. After the Sender 150 confirms accuracy of the PIN Number 195 or Password, the Sender 150 furnishes to WTC cash through either internet based money transfer methods, ATM 225, Bank 226, or other Retail Outlet 227.

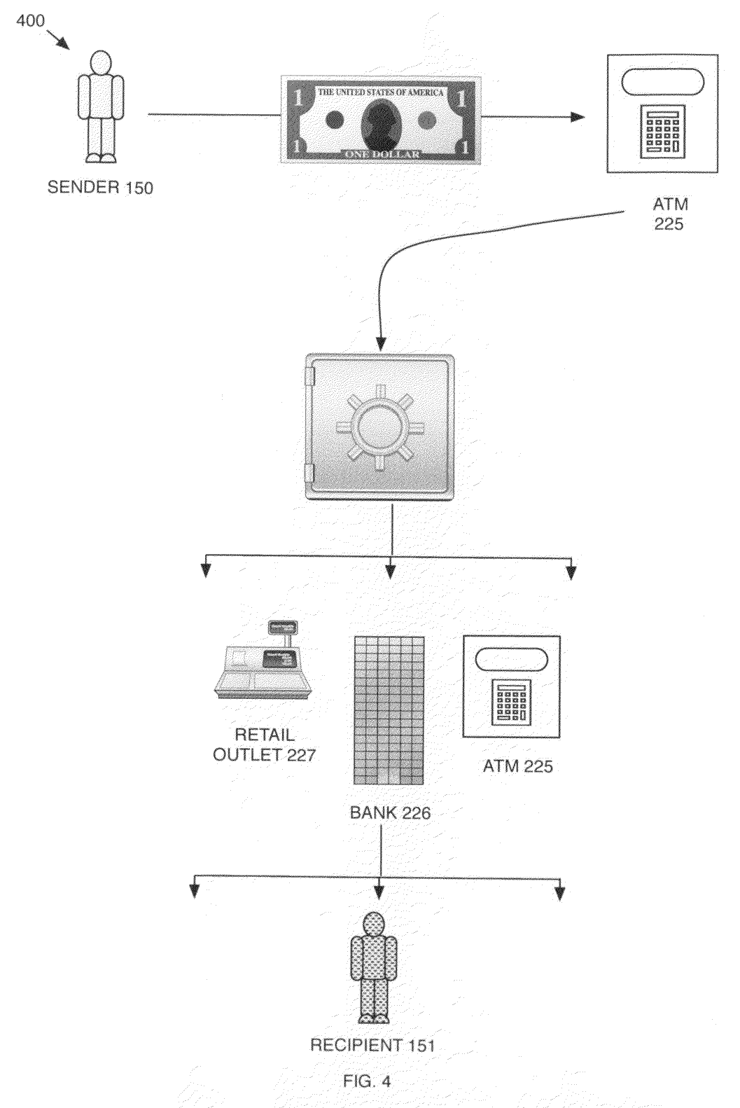

FIG. 4 illustrates another preferred embodiment of the present invention. A Cash Transfer Method 400 includes the steps of: 1. Accepting a transfer of funds 401 from an ATM Scanning apparatus, 2. Wiring the funds 402 into an Account, 3. Accepting or Generating a PIN Number 403 for Sender 4. Accepting a PIN Number 404 from a recipient, 4. Comparing the PIN Number 404 furnished by the Recipient with a PIN Number previously generated, 5. Disbursing funds 405 to Recipient.

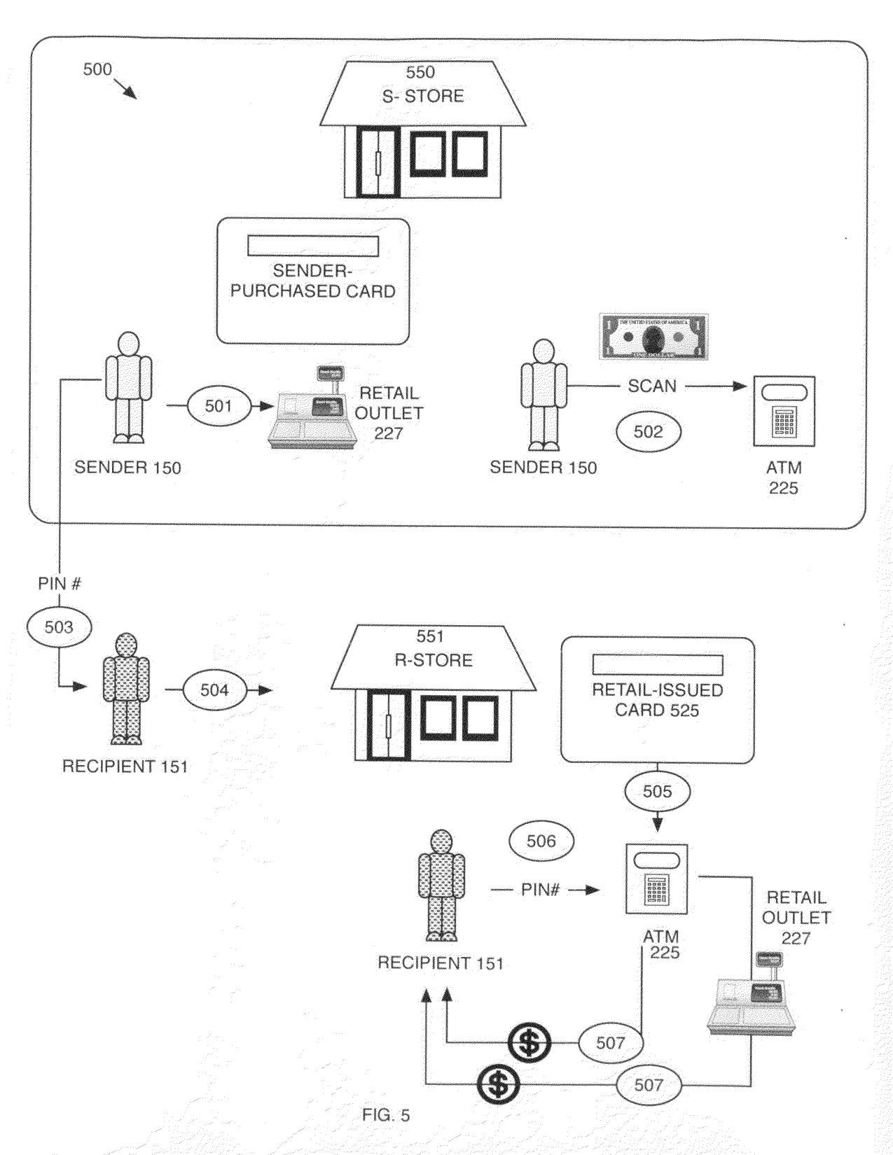

FIG. 5 illustrates another preferred embodiment of the present invention. A Store Initiating and Disbursing Method 500 for Transferring Funds includes the steps of: 1. Accepting funds 501 from a Sender, 2. Attributing a PIN number 502 to the funds provided by Sender, 3. Accepting a PIN number 503 furnished by a Recipient and information associated with a Retail-Issued Card, 4. Comparing the PIN number 504 associated with the funds from the Sender with the PIN number provided by the Recipient 151 furnished with information associated with the Retail-Issued Card, and 5. Disbursing Funds 505 from the Sender to the Recipient 151 through a person, entity, or device with access to the Retail-Issued Card.

It should be noted here that the transaction is initiated by a sender in a predetermined S-Store 550. Also, the transaction is consummated, or the funds are disbursed to the recipient at a predetermined R-Store 551. Each predetermined store will be furnished with a Retail Issued Card 525. In order for the Recipient 151 to acquire the funds, the Recipient 151 will notify the R-Store 551 that he or she is awaiting a wire transfer from Sender 150. Thereafter, the R-Store 551 will swipe the Retail Issued Card 525 into a card reader or similar device which will be in communication with the WTC. After the Recipient 151 furnishes the proper PIN Number 195, the R-Store 551 will remit the funds, or products/services approximately equivalent in value to the funds sent by Sender 150.

It should be noted here that the S-Store 550 and the R-Store 551 may be the same store in certain situations. In addition, the S-Store 550 and the R-Store 551 may be controlled by the same entity, but operated at different locations.

In some preferred embodiments, the Sender 150 can specifically request how the funds are to be allocated in the R-Store 551. For instance, if a parent Sender 150 desires for their son Recipient 151 to only spend the funds for books, food, etc., instead of other goods, services, or cash, the Sender 150 can specifically provide instructions as to how the funds are to be spent.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

1-15. (canceled)

16. A method of transferring funds comprising the steps of:
supplying funds from a sender through a web-enabled wire transfer entity using a computer platform;
accepting said funds by a retailer using a computer platform;
providing a transaction number to enable receipt of said funds by a recipient;
entering said retailer's establishment by said recipient to provide notice to said retailer of said recipient's intent to receive said funds;
accessing a previously obtained retailer-specific card by said retailer wherein said card is maintained and kept by said retailer;
utilizing said card in said retailer's ATM machine to retrieve said web-enabled wire transferred funds; and
entering said transaction number by said recipient in said ATM to retrieve said funds.

17. The method of transferring funds as defined in claim 16 wherein said transaction number is provided through said web-enabled wire transfer entity using said computer platform.
